(19) United States
(12) Patent Application Publication
(10) Pub. No.: US 2024/0179096 A1
(43) Pub. Date: May 30, 2024

(54) VEHICLE-MOUNTED APPARATUS, CONTROL SERVER, METHOD FOR COLLECTING MEASUREMENT DATA AND PROGRAM RECORDING MEDIUM

(71) Applicant: NEC Corporation, Minato-ku, Tokyo (JP)

(72) Inventors: Kosei KOBAYASHI, Tokyo (JP); Shintaro CHIKU, Tokyo (JP); Yoko TANAKA, Tokyo (JP); Yuki TSUJI, Tokyo (JP); Kazuki OGATA, Tokyo (JP); Kei YANAGISAWA, Tokyo (JP); Natsumi YOKOYAMA, Tokyo (JP)

(73) Assignee: NEC Corporation, Minato-ku, Tokyo (JP)

(21) Appl. No.: 18/283,858

(22) PCT Filed: Mar. 29, 2021
(86) PCT No.: PCT/JP2021/013186

§ 371 Date: Sep. 25, 2023

(51) Int. Cl. H04L 47/2425; G01B 11/30; H04L 67/12

(52) U.S. Cl. CPC H04L 47/2433; G01B 11/303; H04L 67/12

(57) ABSTRACT

A vehicle-mounted apparatus comprises a measurement part capable of measuring, by means of a sensor, a road surface state in which a vehicle travels, a band evaluation part that evaluates a network band between it and a server at a transmission destination of measurement data of the road surface state, an importance calculation part that calculates importance of the measurement data based on a predetermined importance determination policy, a transmission part capable of transmitting the measurement data to the server, and a control part that controls transmission of the measurement data to the server by the transmission part based on evaluation of the network band and the importance of the measurement data.

### TECHNICAL FIELD

The present disclosure relates to a vehicle-mounted apparatus, a control server, a method for collecting measurement data, and a program recording medium.

### BACKGROUND ART

In recent years, proposed is a method for measuring and checking a state of a road surface of a road using a general vehicle, in addition to a method using a dedicated road surface property measuring vehicle. For example, a patent literature 1 discloses a road surface state estimation apparatus capable of properly estimating a state of a road surface. The literature discloses that this road surface state estimation apparatus is provided with acquisition means to acquire from a vehicle behavior information about behavior of the vehicle, judgment means to judge based on the behavior information whether an abnormality condition is satisfied which is determined based on a specific behavior which a vehicle is presumed to exhibit when the vehicle encounters a road surface abnormality, and estimation means to estimate a state of a road surface based on the result judged by the judgment means.

A patent literature 2 discloses a pavement management and assistance system capable of determining the priority of countermeasures, taking account of importance of a road in addition to a degree of deterioration of pavement. The literature discloses that this pavement management and assistance system sets an evaluation index for carrying out a repair plan of pavement for each section and is provided with deterioration determination means, importance determination mean and total score calculation means. It is disclosed that among those the deterioration determination means determines “deterioration score” indicative of a degree of deterioration of pavement of a target section based on a value of MCI and determines “importance score” indicative of importance of pavement of a target section based on two or more of “evaluation items”, and the total score calculation means calculates “total score” based on the deterioration score and the importance score. Herein, MCI stands for Maintenance Control Index and is used as an index of maintenance and management (control) of pavement.

### CITATION LIST

### Patent Literature

[PTL 1] Japanese Patent Kokai Publication No. 2020-13537A
[PTL 2] Japanese Patent Kokai Publication No. 2019-36182A

### SUMMARY OF INVENTION

### Technical Problem

The following analysis is given by the inventors. In the method of the patent literature 1, a vehicle having travelled a road transmits measurement data to a device called a road surface state estimation device. Accordingly, some statuses of a network band cause such a problem that measurement data transmitted in a large amount are going to press a network band between the vehicle and the road surface state estimation device.

In order to avoid the situation that the network band is going to be pressed, it is conceivable to sort measurement data to be transmitted by certain criteria. However, sorting by uniform criteria causes such a problem that transmission of measurement data is going to be suppressed even if a network band has a margin.

In this regard, the patent literature 2 does not go beyond disclosing that “total score” is calculated based on “deterioration score” indicative of a degree of pavement of a target section and “importance score” indicative of importance of pavement of a target section.

An example object of the present disclosure is to provide a vehicle-mounted apparatus, a control server, a method for collecting measurement data and a computer recording medium, which are able to contribute to optimization of transmission of measurement data from the measuring vehicle.

### Solution to Problem

According to a first aspect, provided is a vehicle-mounted apparatus, comprising a measurement part capable of measuring, by means of a sensor, a road surface state in which a vehicle travels, a band evaluation part that evaluates a network band between it and a server at a transmission destination of measurement data of the road surface state, an importance calculation part that calculates importance of the measurement data based on a predetermined importance determination policy, a transmission part capable of transmitting the measurement data to the server, and a control part that controls generation of the measurement data by the measurement part or transmission of the measurement data to the server by the transmission part based on the network band and the importance of the measurement data.

According to a second aspect, provided is a control server comprising a band evaluation part that evaluates a network band between a vehicle including a measurement part capable of measuring, by means of a sensor, a road surface state in which the vehicle travels, an importance calculation part that calculates importance of the measurement data based on a predetermined importance determination policy, a transmission part capable of transmitting the measurement data of the road surface state to the server and a control part, and a server at a transmission destination of the measurement data, and a notification part that notifies the vehicle of the network band, the control server allowing the control part of the vehicle to control generation of the data by the measurement part of the vehicle or measurement transmission of the measurement data to the server by the transmission part of the vehicle based on the network band and importance of the measurement data.

According to a third aspect, provided is a method for collecting measurement data, wherein a vehicle-mounted apparatus of a vehicle including a measurement part capable of measuring, by means of a sensor, a road surface state in which the vehicle travels and a transmission part capable of transmitting measurement data of the road surface state to a server evaluates a network band between it and a server at a transmission destination of the measurement data, calculates importance of the measurement data based on a predetermined importance determination policy, and controls generation of the measurement data by the measurement part or transmission of the measurement data to the server by the transmission part based on the network band and importance of the measurement data. This method is associated to a specific machine which is a vehicle-mounted apparatus of a vehicle capable of measuring the road surface state.

According to a fourth aspect, provided is a method for collecting measurement data, wherein a control server provided with a communication part capable of communication with a vehicle-mounted apparatus of a vehicle including a measurement part capable of, by means of a sensor, measuring a road surface state in which the vehicle travels, a importance calculation part that calculates importance of measurement data based on a predetermined importance determination policy, a transmission part capable of transmitting measurement data of the road surface state to the server, and a control part evaluates a network band between it and a server at a transmission destination of the measurement data, notifies the vehicle-mounted apparatus of the vehicle of the network band, and allows the control part of the vehicle to control generation of the measurement data by the measurement part of the vehicle or transmission of the measurement data to the server by the transmission part of the vehicle based on the network band and importance of the measurement data. This method is associated to a specific machine which is a control server provided with a communication part capable of communication with the vehicle-mounted apparatus.

According to a fifth aspect, provided is a computer program for implementing each function of the aforementioned vehicle-mounted apparatus and control server (hereinafter referred to as “program”). This program is input into a computer apparatus via an input device or a communication interface from outside, stored in a storage device, and drives a processor according to predetermined steps or processes. Further, this program can display process results including intermediate statuses as required via a displaying device in a stepwise manner, or can communicate with the outside via a communication interface. A computer apparatus therefor comprises, as an example, a processor, a storage device, an input device, a communication interface and, as required, a displaying device, which typically can be connected to one another via a bus. Furthermore, this program is recordable in a computer-readable (non-transitory) storage medium.

### Advantageous Effects of Invention

According to the present disclosure, it is possible to optimize transmission of measurement data from a measuring vehicle.

### BRIEF DESCRIPTION OF DRAWINGS

FIG. 1 is a diagram illustrating a configuration of an example embodiment of the present disclosure.

FIG. 2 is a diagram illustrating operations of an example embodiment of the present disclosure.

FIG. 3 is a diagram illustrating a configuration of a first example embodiment of the present disclosure.

FIG. 4 is a functional block diagram illustrating a configuration of a measuring vehicle according to the first example embodiment of the present disclosure.

FIG. 5 is a diagram illustrating an example of a table referred to by a control part of the measuring vehicle according to the first example embodiment of the present disclosure.

FIG. 6 is a flow chart illustrating an operation of the measuring vehicle according to the first example embodiment of the present disclosure.

FIG. 7 is a diagram illustrating a configuration of a second example embodiment of the present disclosure.

FIG. 8 is a functional block diagram illustrating configurations of a measuring vehicle and a road inspection server according to the second example embodiment of the present disclosure.

FIG. 9 is a flow chart illustrating an operation of the measuring vehicle according to the second example embodiment of the present disclosure.

FIG. 10 is a diagram illustrating another example of a table referred to by a control part of a measuring vehicle according to the present disclosure.

FIG. 11 is a diagram illustrating a further example of a table referred to by a control part of a measuring vehicle according to the present disclosure.

FIG. 12 is a diagram illustrating a configuration of a computer mounted on a measuring vehicle according to the present disclosure.

FIG. 13 is a diagram for explaining an operation of an example embodiment according to the present disclosure.

### EXAMPLE EMBODIMENTS

First, an outline of an example embodiment of the present disclosure will be described in reference to the drawings. It is to be noted that reference symbols added to this outline are added to individual elements for convenience, as an example for aiding understanding, and are not intended to limit the present disclosure to modes illustrated in the drawings. Further, connection lines between blocks in the diagrams referred to in the following explanation include both unidirectional or bidirectional. Unidirectional arrows schematically show a flow of main signals (data), but do not exclude bidirectionality. A program is executed via a computer apparatus, which is provided with, for example, a processor, a storage device, an input device, a communication interface and, as required, a displaying device. Further, this computer apparatus is so configured to be able to communicate in a wired or wireless way with devices therein or outside it (including a computer) via a communication interface. Furthermore, there are ports or interfaces at connection points of an input and an output of each block in the figures, which are not shown therein.

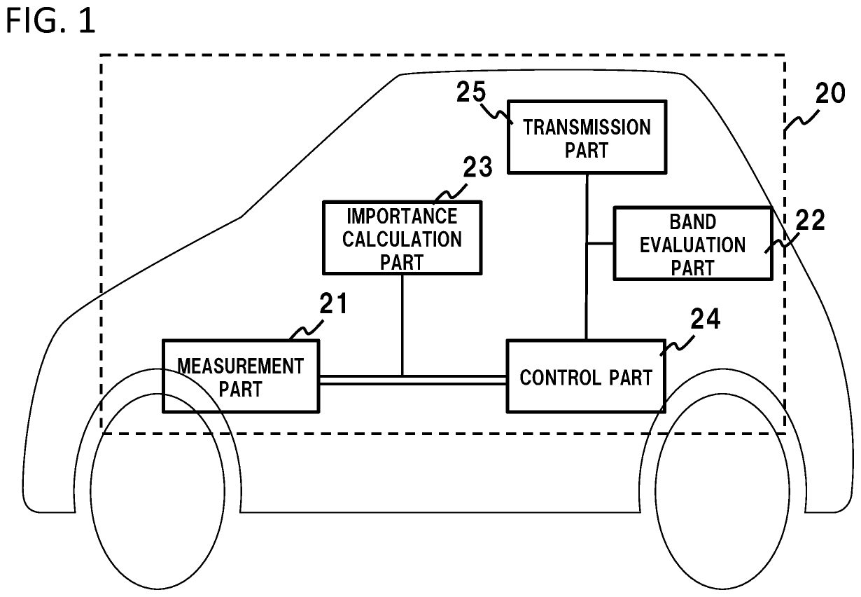

In an example embodiment, the present disclosure is implemented by a vehicle-mounted apparatus 20 provided with a measurement part 21, a band evaluation part 22, an importance calculation part 23, a control part 24 and a transmission part 25, as shown in FIG. 1.

More concretely, the measurement part 21 is so configured to be capable of measuring, by means of a sensor, a state of a road surface on which a vehicle travels.

The band evaluation part 22 evaluates a network band between it and a server receiving measurement data of the road surface state. This “network band” can be evaluated by, for example, a value of “throughput” indicative of an amount of data transmittable per unit time (effective transfer rate, for example, XX Mbps). For example, “network band” is evaluated as “HIGH” in a case where a throughput value exceeds a predetermined threshold value, and “network band” is evaluated as “LOW” in a case where a throughput value is equal to or less than the predetermined threshold value.

The importance calculation part 23 calculates (a degree of) importance of the measurement data based on a predetermined importance determination policy. The predetermined importance determination policy may be able to calculate importance of measurement data, not restricted to a specific one. For example, the policy may be, for example, one that evaluates importance of measurement data of a road surface state of a road having a high service request level such as a national road, a prefectural road etc. as “HIGH” and importance of measurement data of a road surface state of a road of other types as “LOW”.

The control part 24 controls generation of the measurement data by the measurement part 21 or transmission of measurement data measured by the measurement part 21 to the server. In concrete, the control part 24 determines a threshold value for (a degree of) importance of measurement data based on a network band, compares the threshold value with importance of measurement data, and controls generation or transmission of measurement data. The transmission part 25 is so configured to be capable of transmitting measurement data of the road surface state to the server.

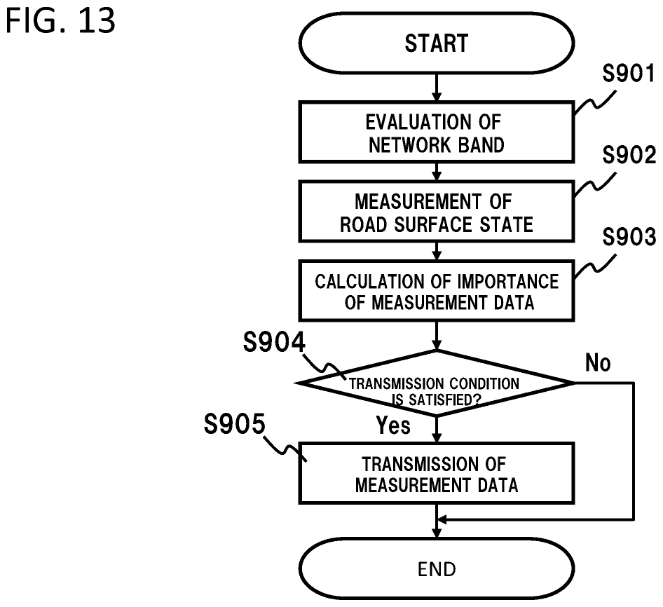

FIG. 13 is a diagram illustrating an example of an operation of the above-mentioned vehicle-mounted apparatus 20. Referring to FIG. 13, the vehicle-mounted apparatus 20, first, evaluates a network band between it and a server at a transmission destination of the measurement data (step S901). Next, the vehicle-mounted apparatus 20 measures, by means of a sensor, a state of a road surface on which the vehicle travels (step S902). Then, the vehicle-mounted apparatus 20 calculates (a degree of) importance of the measurement data based on a predetermined importance determination policy (step S903). And then, the vehicle-mounted apparatus 20 judges whether the measurement data satisfy a predetermined transmission condition (step S904). As a result of the judgment, in a case where it judged that it transmits the measurement data, the vehicle-mounted apparatus 20 transmits the measurement data to the server (step S905).

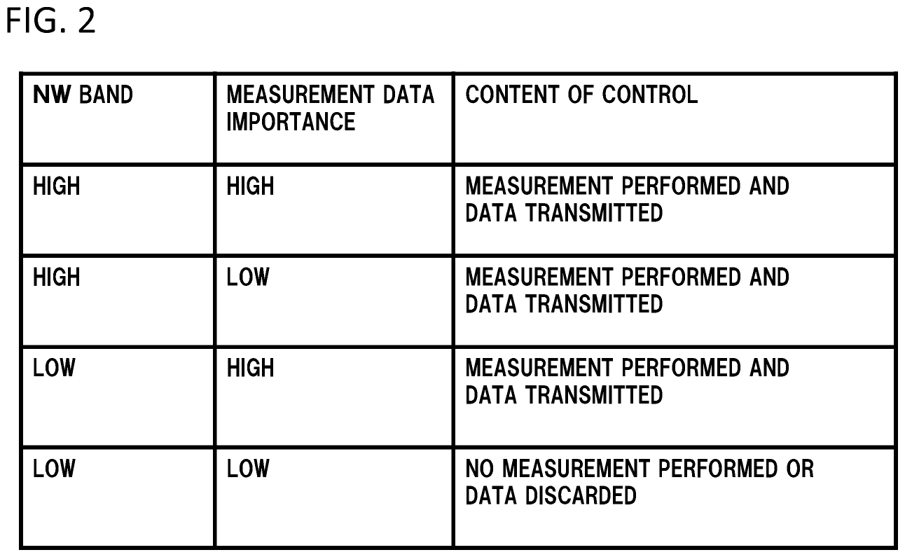

FIG. 2 is a diagram for illustrating an example of an operation of the control part 24 in the step S904. In a case where the network band is “HIGH”, the control part 24 judges that measurement and data transmission are performed regardless of whether importance of measurement data is high or low, and controls the measurement part 21 and the transmission part 25. That is, the control part 24 determines a threshold value of importance of the measurement data based on the network band, and compares the determined threshold value and the importance of the measurement data, thereby determining whether generation of the measurement data is necessary or not or whether transmission of the measurement data to the server is necessary or not. On the other hand, in a case where it evaluated that the network band is lower than the predetermined threshold value, the control part 24 controls the transmission part 25 so as to suppress transmission of measurement data of low importance. That is, in a case where a network band evaluated is a second evaluation value lower than a first evaluation value, the control part 24 is so operated to suppress transmission of measurement data whose importance is equal to or lower than a predetermined threshold value. It is to be noted that measurement data whose importance is higher than the predetermined threshold value is targeted to transmission (becomes a transmission object) to a server.

As described above, the example embodiment makes it possible to optimize transmission of measurement data from a measuring vehicle. The reason is that it adopts such a configuration that the vehicle-mounted apparatus 20 evaluates importance of measurement data and a network band respectively and dynamically controls transmission of measurement data according to the result.

Further, the function of the control part 24 can be achieved by such a way that the control part 24 changes a threshold value to be compared with importance of measurement data. In this case, the control part 24 determines a threshold value for comparison with importance of measurement data based on the network band. Then, the control part 24 compares the determined threshold value and the importance of the measurement data and controls generation of the measurement data by the measurement part 21 or transmission of measurement data measured by the measurement part 21 to the server.

More concretely, in a case where evaluation of the network band is relatively low, the control part 24 changes a threshold value for comparison with importance of the measurement data to a value higher than a threshold value in a case of evaluation of the network band being relatively high. Then, by comparison with a threshold value whose value after this change is high, the control part 24 controls so as to do generation or transmission of measurement data of high importance.

Further, it is described in the foregoing that a threshold value for comparison with importance of the measurement data is increased in a case where evaluation of a network band is relatively low. However, such a control may be done that the predetermined threshold value is decreased in a case where evaluation of a network band is relatively high. Thereby, transmission of more measurement data is done in a case where evaluation of a network band evaluated is relatively high.

Moreover, it is described in the foregoing that transmission of measurement data is suppressed on the premise that measurement data are transmitted. However, it can be so configured that the control part 24 transmits measurement data based on a network band and importance of measurement data only if a condition(s) is(are) satisfied.

### First Example Embodiment

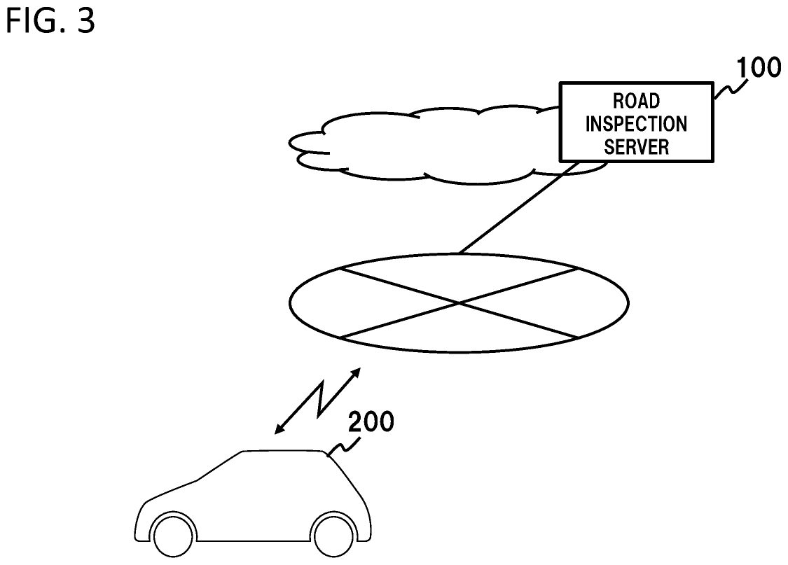

Next, a first example embodiment of the present disclosure will be described in detail in reference to the drawings. FIG. 3 is a diagram illustrating a configuration according to the first example embodiment of the present disclosure. Referring to FIG. 3, shown is a configuration that a road inspection server 100 and a measuring vehicle 200 equipped with a vehicle-mounted apparatus are connected with one another via a network. It is to be noted that the example of FIG. 3 shows one measuring vehicle 200, but it may be so configured that a plurality of measuring vehicles 200 transmit measurement data to a road inspection server 100.

The road inspection server 100 receives measurement data from the measuring vehicle 200 and performs inspection of a road surface state. For example, the road inspection server 100 calculates, from measurement data received from the measuring vehicle 200, a cracking ratio of a road, a rutting amount of a road, IRI (International Roughness Index) etc. and performs inspection of a road based thereon. Further, a measurement item which is a flatness can be provided instead of the IRI. Moreover, such a configuration, too, can be adopted that these measurement items are used to calculate MCI (Maintenance Control Index) and perform inspection.

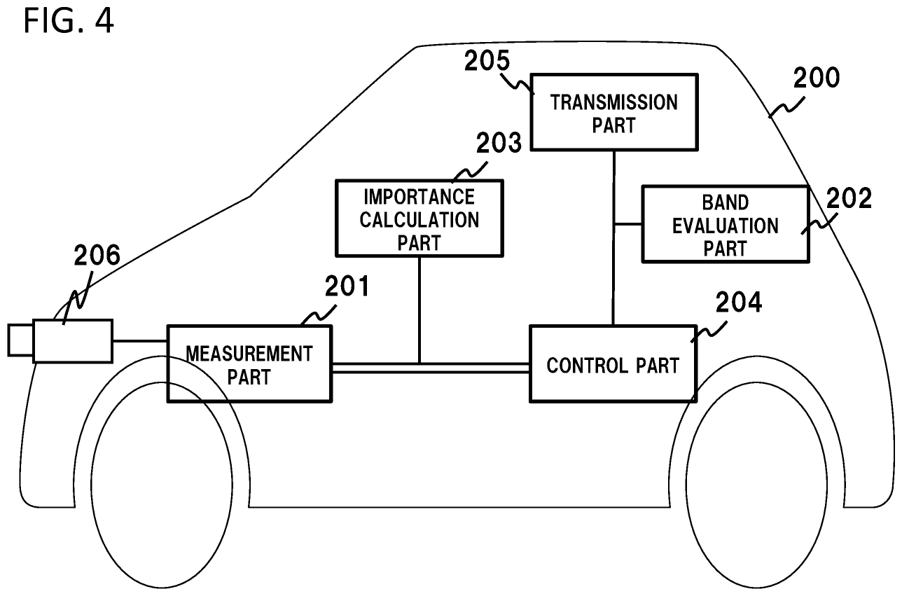

FIG. 4 is a diagram illustrating a configuration of a measuring vehicle according to the first example embodiment of the present disclosure. The measuring vehicle 200 is provided with a measurement part 201, a band evaluation part 202, an importance calculation part 203, a control part 204 and a transmission part 205 as the vehicle-mounted apparatus. These may be configured as an integral unit or arranged by being distributed in a plurality of units.

The measurement part 201 is connected to a camera 206 as a sensor and generates measurement data of a road surface state using the camera 206. It is to be noted that the camera 206 may be an infrared camera or a camera using a millimeter wave in addition to an optical camera photographing in the visible light range. In addition, LiDAR (Light Detection and Ranging) may be used as a sensor.

The band evaluation part 202 evaluates a network band (a band of a network) used for transmission of measurement data between the measuring vehicle 200 and the road inspection server 100. The method of evaluating a network band includes a method of directly evaluating a throughput itself and a method of indirectly evaluating a throughput from other indices. The former method of directly evaluating a throughput itself can use throughput measurement approaches and throughput estimation approached of various types in addition to a method of measuring a throughput by transmitting and receiving measurement traffics with an instrument(s) on the side of the road inspection server 100. Further, because a wireless section is often a bottleneck in evaluation of a network band, it may be possible to estimate a band of the wireless section and treat it as a network band between the measuring vehicle 200 and the road inspection server 100. The method of indirectly estimating (evaluating) a throughput of a wireless communication network from other indices includes the following.
wireless (radio) quality of a wireless communication network (reception power, desired wave versus interference wave power ratio)
a frequency bandwidth of a wireless communication network (10 MHz width, 100 MHz width etc.)
congestion degree of a wireless communication network (wireless resource usage rate, the number of connection users etc.)
type of a wireless communication network (LTE (Long Term Evolution), 5G, WiFi (registered trademark) etc.).

Further, a network band may be evaluated using a time zine or a load of a road inspection server in addition to the aforementioned individual indices. For example, in a case where an evaluation value of a network band for each time zone is obtained statistically, an evaluation value obtained statistically can be used as an evaluation value of the time zone concerned. Furthermore, in a case where a load of a road inspection server is proximate to an evaluation value of a network band, a value obtained from a load of a road inspection server can be regarded as an evaluation value of a network band.

An evaluation value of a network band by the band evaluation part 202 may be a value of a throughput measured or estimated as mentioned above, or a discrete or qualitative classification result about a throughput (examples: 1 to 5 in five-grade evaluation, high, middle and low in three-grade evaluation etc.).

The importance calculation part 203 calculates (a degree of) importance of the measurement data. The importance of the measurement data can be calculated by a combination of one or more of the following informational items.

### Type of Road of a Measurement Object (Road Targeted for Measurement)

For example, as to a road, in a case where a road type is set based on difference in a service request level or a road administrator, importance can be set according to this road type. It is to be noted that a position of a vehicle-mounted apparatus can be specified by GPS (Global Positioning System) information or information from a neighboring roadside machine and a road on which measurement is to be started can be specified based on that positional information.

### Reliability of Measurement Data

For example, in a case where data are measured under a circumstance unsuitable for measurement, it can be said that reliability of such data is decreased. Reliability of measurement data can be obtained by quantifying an environment in which the data were measured using a degree of environment suitable for measurement. For example, an image included in measurement data is influenced generally by brightness of photographing environment, weather when photographing, sway of measuring vehicle, vehicle speed etc. and, for example, image quality is deteriorated in a case where photographing environment is dark. In a case where data are measured under a circumstance under which image quality is deteriorated in this way, reliability of measurement data is decreased. Importance of such data of low reliability can be decreased.

### Severity of Road Deterioration

In a case where a pothole or a crack is displayed on an image obtained by photographing a road surface state, it is necessary to do emergency repair from the standpoint of safety control, and a road administrator needs to grasp its size or judge whether repair is needed. This severity of a road deterioration can be obtained, for example, by a size of a deterioration area displayed on an image.

The transmission part 205 transmits measurement data of a road surface state generated in the measurement part 201 to the road inspection server 100. It is to be noted that measurement data which the transmission part 205 transmits to the road inspection server 100 may include, in addition to measurement data targeted for transmission (becoming a transmission object) based on importance of measurement data of the network band, measurement data around the same. In other words, the control part 204 controls the measurement part 201 or the transmission part 205 so as to generate temporally successive measurement data including certain measurement data or transmit the measurement data to the server. By doing so, it is made possible to facilitate, for example, an analysis in the road inspection server 100 on a specific abnormal mode such as a crack of a certain length.

The control part 204 controls measurement of the road surface state by the measurement part or transmission of the measurement data to the server by the transmission part based on the evaluated network band and the importance of the measurement data.

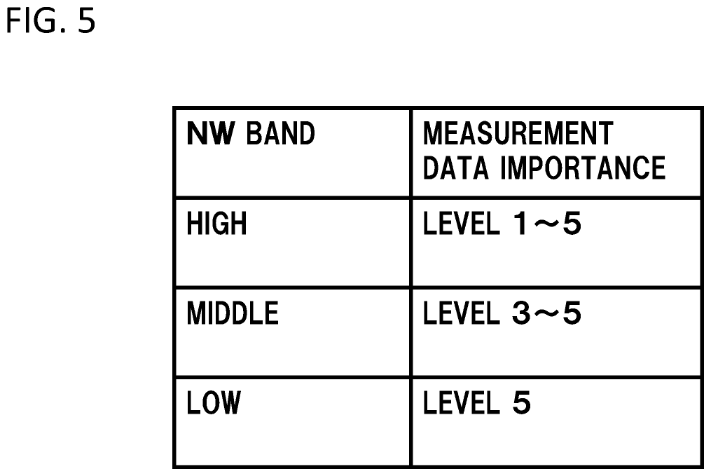

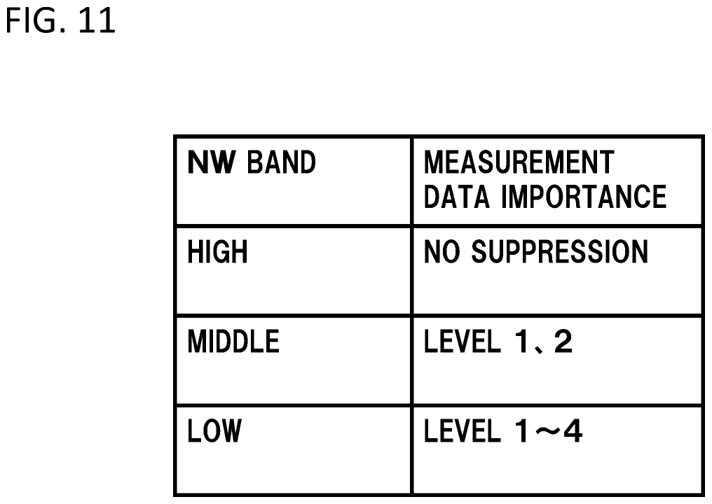

For example, the control part 204 can adopt a configuration which controls transmission of the measurement data to the server by referring to a table in which combinations of the classified network bands and the importance of the measurement data are set. This table can be prepared by classifying a network band and assigning an importance threshold value to each of the classes. For example, in a case where the network band is evaluated (classified) in a three-grade of high, middle and low and importance of measurement data is given in a five-grade of 5 to 1 in the descending order of importance, the control part 204 judges whether transmission of data is necessary by referring to a table shown in FIG. 5. In the example of FIG. 5, in a case where a network band is “HIGH”, the control part 204 transmits all measurement data of importance levels 1 to 5 to the road inspection server 100. In other words, in a case where a network band is “HIGH”, an importance threshold value is given a level 1. Alternatively, because all measurement data of importance levels 1 to 5 are transmitted in a case where a network band is “HIGH”, an importance threshold value may be given no setting. Likewise, in a case where a network band is “MIDDLE”, the control part 204 transmits measurement data of importance levels 3 to 5 to the road inspection server 100. In other words, in a case where a network band is “MIDDLE”, an importance threshold value is given a level 3. Further, in a case where a network band is “LOW”, the control part 204 transmits measurement data of importance level 5 to the road inspection server 100. In other words, in a case where a network band is “LOW”, an importance threshold value is given a level 5. In this way, the control part 204 is so operated to limit measurement data being a transmission object (targeted for transmission) to the ones of higher importance as an evaluation value of a network band is lowered. It is to be noted that the example of FIG. 5 defines combinations of a network band which is a condition for transmission of measurement data and importance of the measurement data, but a table which defines combinations of a network band which is a condition for suppressing transmission of measurement data and importance of the measurement data, as shown in FIG. 11, may be used. It may be conceivable that also the table shown in FIG. 11 is given importance threshold values according to a network band.

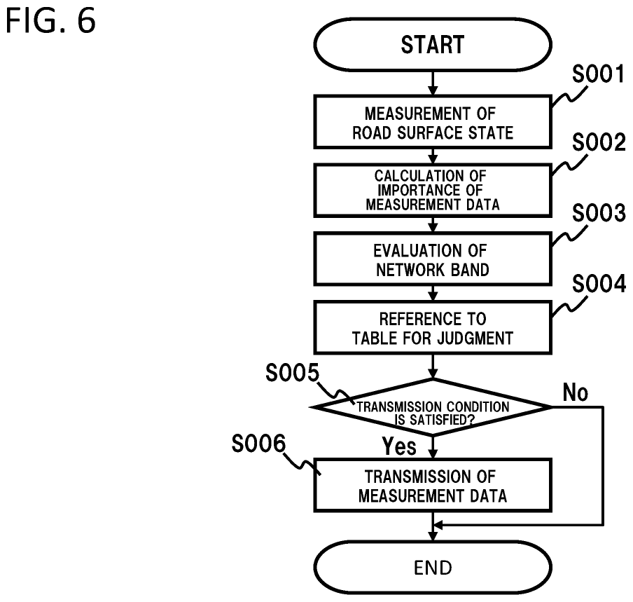

Then, an operation of this example embodiment will be described in detail in reference to the Drawings. FIG. 6 is a flow chart showing an operation of a measuring vehicle according to the first example embodiment of the present disclosure. Referring to FIG. 6, a vehicle-mounted apparatus equipped in a measuring vehicle 200, first, starts to measure a road surface state at a predetermined timing such as an arrival at a starting point of a road designated previously, an operation of start of measurement by a user etc. (step S001).

Next, the vehicle-mounted apparatus equipped in the measuring vehicle 200 calculates (a degree of) importance of data measured (step S002). Herein, explanation will be done assuming that the vehicle-mounted apparatus calculates scores by combining three items of a type of a road being a measurement object (targeted for measurement), reliability of measurement data and severity of road deterioration and five-grade importance 5 to 1 are given to the scales in the descending order.

Next, the vehicle-mounted apparatus equipped in the measuring vehicle 200 evaluates a network band (step S003). Here, explanation will be done assuming that the vehicle-mounted apparatus determines scores from wireless quality of a wireless communication network (reception power, desired wave versus interference wave power ratio) and evaluates a network band in a three-grade of high, middle and low.

The vehicle-mounted apparatus equipped in the measuring vehicle 200 judges whether to transmit measurement data, by referring to the table shown in FIG. 5 (steps S004, S005). For example, in a case where measurement data importance is “3”, the vehicle-mounted apparatus judges as follows. In a case where evaluation of a network band is “HIGH” or “MIDDLE”, the vehicle-mounted apparatus judges that measurement data should be transmitted. On the one hand, in a case where evaluation of a network band is “LOW”, the vehicle-mounted apparatus judges that transmission of measurement data is unnecessary.

On the other hand, in a case where measurement data importance is “1”, the vehicle-mounted apparatus judges that measurement data should be transmitted, only if evaluation of a network band is “HIGH”. In a case where evaluation of a network band is “MIDDLE” or “LOW”, the vehicle-mounted apparatus judges that transmission of measurement data is unnecessary. This is because importance of measurement data is low.

Further, in a case where importance of measurement data is “5”, the vehicle-mounted apparatus judges that measurement data should be transmitted, in all cases of evaluation of a network band being “HIGH” to “LOW”. This is because importance of measurement data is high.

In a case of judging that transmission is necessary in step S005, the vehicle-mounted apparatus equipped in the measuring vehicle 200 transmits measurement data of a road surface state generated in the measurement part 201 to the road inspection server 100 (step S006). It is to be noted that in the example shown in FIG. 6, the processes in steps S001, S002 and S003 are performed in this order, but these processes can be appropriately exchanged with one another if importance of measurement data is calculated after measurement of a road surface state. For example, steps S001 and S002 may be performed after evaluation of a network band in step S003. Further, it may be done that evaluation of a network band in step S003 is performed after measurement of a road surface state, followed by calculation of importance of measurement data. Of course, steps S001 and S002 may be performed in parallel with step S003.

As described above, this example embodiment makes it possible to optimize transmission of measurement data from the measuring vehicle 200. The reason is that it adopts such a configuration as to perform not only calculation of importance of measurement data but also evaluation of a network band, and judge based on the both whether transmission of measurement data is necessary.

It is to be noted that in FIG. 5 a relationship between a value (including a range) of band evaluation and a threshold value of importance targeted for transmission (rendered a transmission object) may be a fixed value but may be changed based on a time zone, actual data amount and communication quality (example: packet loss). For example, in a case where it is previously obtained (known) from an actual result value such as statistical data that network congestion occurs at a specific time, a value (a range) of evaluation of a network band may be changed to a value higher that a normal one such that transmission of measurement data is suppressed. Further, in a case where an actual result value that an amount of actually generated data is small in comparison to evaluation of a network band is obtained, a value (a range) of evaluation of a network band may be changed to a value lower than a normal one such that measurement data are increased. Furthermore, in a case where an actual result value that an amount of actually generated data is large in comparison to evaluation of a network band is obtained, a value (a range) of evaluation of a network band may be changed to a value higher than a normal one such that measurement data are reduced. Moreover, in a case where deterioration of communication quality is observed for some reason, a value (a range) of evaluation of a network band may be changed to a value higher than a normal one such that transmission of measurement data is suppressed. Of course, in a case where an event opposite to the foregoing is confirmed, a threshold value of evaluation of a network band can be changed to a value lower than a normal one.

The same applies to a threshold value for determining a level of importance, and a threshold value may be changed according to a time zone, an amount of actually measured data, a load of the road inspection server 100 etc. For example, in a case where it is previously obtained (known) from statistical data etc. that network congestion occurs at a specific time, a threshold value for judgment of a level of importance may be changed to a value higher that a normal one such that transmission of measurement data is suppressed. Further, in a case where an actual result value that an amount of actually generated data is small in comparison to evaluation of a network band is obtained, a threshold value for judgment of a level of importance may be changed to a value lower than a normal one such that measurement data are increased. Furthermore, in a case where an actual result value that an amount of actually generated data is large in comparison to evaluation of a network band is obtained, a threshold value for judgment of a level of importance may be changed to a value higher than a normal one such that measurement data are reduced. Likewise, in a case where it is observed that the road inspection server 100 is of a high load state due to processing of a large amount of measurement data, a threshold value for judgment of a level of importance may be changed to a value higher than a normal one such that transmission of measurement data is suppressed. Of course, in a case where an event opposite to the foregoing is confirmed, a threshold value for judgment of a level of importance can be changed to a value lower than a normal one.

In addition, in a case where an increase or decrease in the aforementioned actually measured data, deterioration of communication quality etc. occurs locally, a table itself applied to the area or section concerned may be corrected without performing measurement of actually measured data or communication quality. By doing so, it is made possible, for example, to optimize a value (including a range) of band evaluation or a threshold value of importance based on an actual result of communication when travelling the same place in the past.

### Second Example Embodiment

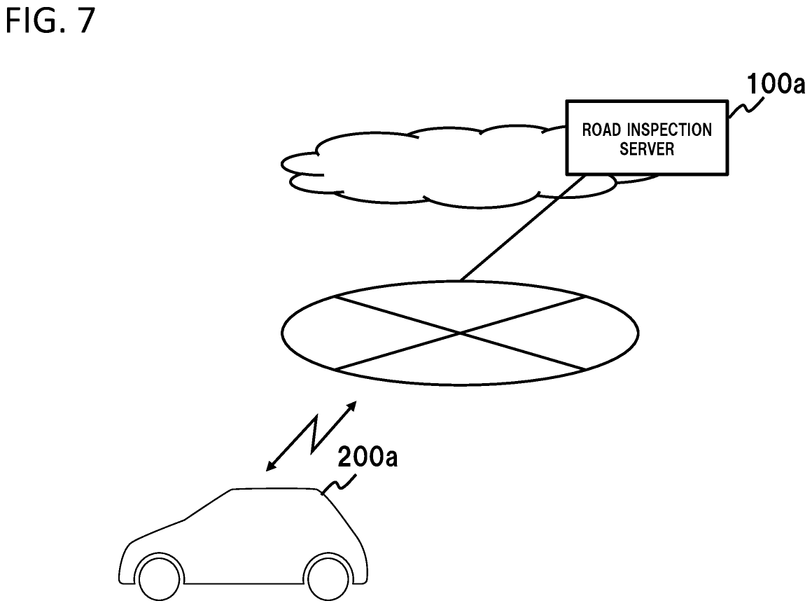

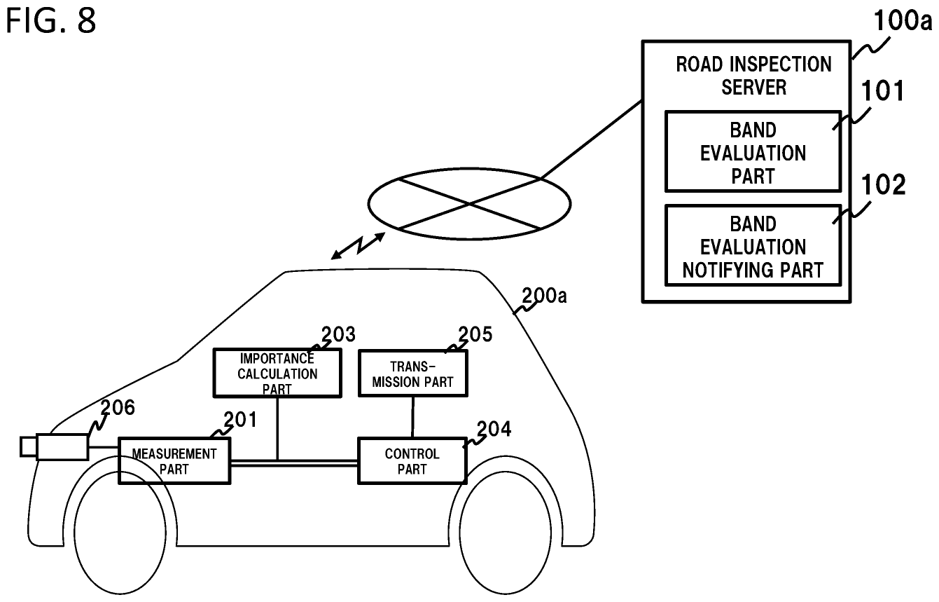

Subsequently, a second example embodiment that an evaluation function of a network band is provided on the side of a road inspection server will be described. FIGS. 7, 8 are diagrams illustrating a configuration according to the second example embodiment of the present disclosure. A difference in configuration from the first example embodiment shown in FIGS. 3, 4 is that the band evaluation part 101 is provided in the road inspection server 100a and functions as a control server. Accordingly, the road inspection server 100a is provided with a band evaluation notifying part 102. Since the other structures are substantially the same as those of the first example embodiment, the difference will be mainly described hereinafter.

A band evaluation part 101 evaluates a network band used for transmission of measurement data between a measuring vehicle 200a and a road inspection server 100a. As a method of evaluating a network band, the same method as that of the first example embodiment can be used and thus explanation thereof is omitted.

A band evaluation notifying part 102 notifies the measuring vehicle 200a of evaluation information about the evaluated network band.

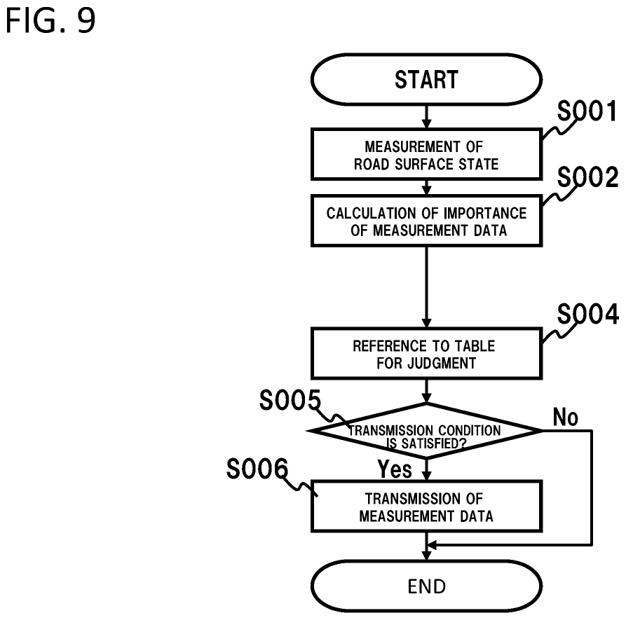

Then, an operation of this example embodiment will be described in detail in reference to the Drawings. FIG. 9 is a flow chart showing an operation of a measuring vehicle according to the second example embodiment of the present disclosure. The following explanation assumes that the measuring vehicle 200a receives from the band evaluation notifying part 102 of the road inspection server 100a evaluation information about a network band at a predetermined timing such as a predetermined time interval, a request from the measuring vehicle etc.

Different from the operation of the measuring vehicle of the first example embodiment shown in FIG. 6, a process of evaluation of a network band in step S003 is omitted. Since the other operations are the same as those of the first example embodiment, explanation is omitted.

As described above, the present disclosure can be achieved also in the configuration that an evaluation function of a network band is provided on the side of the road inspection server 100a. It is to be noted that in the aforementioned example embodiment, it is explained that the road inspection server 100a evaluates a network band, but a server etc. other than the road inspection server 100a may be made to evaluate a network band.

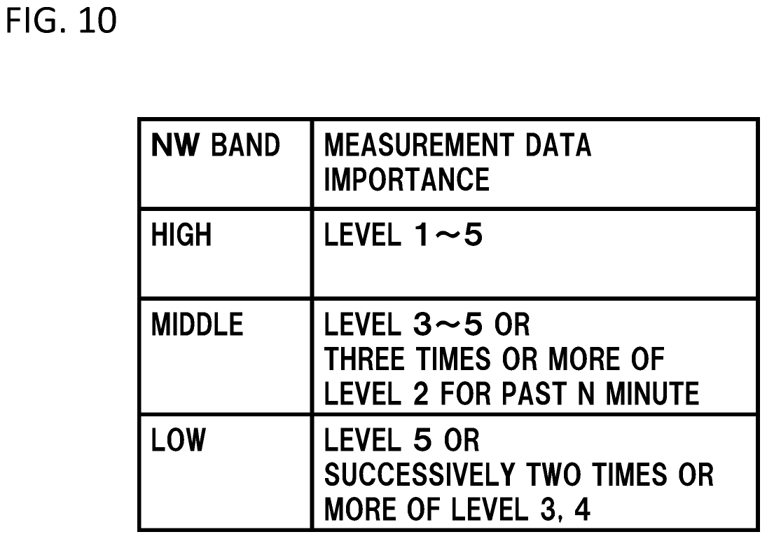

For example, in the aforementioned example embodiment, it is explained that transmission of measurement data is controlled using the tables exemplified in FIG. 2, FIG. 5 and FIG. 11, but a mode (manner) of controlling measurement data is not restricted to the modes exemplified in FIG. 2, FIG. 5 and FIG. 11. For example, even measurement data whose importance level is relatively low could have a significant meaning in light of road management, in a case where they are observed successively for certain times. Likewise, even measurement data whose importance level is relatively low could have a significant meaning in light of road management, in a case where they are observed at a certain frequency for a certain period of time. In order to address transmission of such measurement data, for example, a transmission condition(s) may be added to a table, as shown in FIG. 10. In the example shown in FIG. 10, “successively three times or more of level 2” and “successively two times or more of levels 3, 4” are added as transmission conditions of measurement data in a case where a network band evaluated is “MIDDLE” and “LOW”, respectively. Alternatively, instead of “successively”, a certain frequency or more for a predetermined time interval such as “for the past n minutes” may be used as a transmission condition. This makes it possible to transmit measurement data to the road inspection server 100, 100a from the measuring vehicle 200, 200a in a case where measurement data whose importance is a level 2 is observed three times or more for the past n minutes even if a network band is “MIDDLE”. It can be also said that this renders an importance threshold value a level 2 in a case where measurement data whose importance is a level 2 is observed three times or more for the past n minutes even if a network band is “MIDDLE”. Likewise, it is made possible to transmit measurement data to the road inspection server 100, 100a from the measuring vehicle 200, 200a in a case where measurement data whose importance is a level 3 or 4 is observed two times or more even if a network band is “LOW”. It can be said that an importance threshold value is rendered a level 3 in a case where measurement data whose importance is a level 3 or 4 is observed two times or more even if a network band is “LOW”. It is to be noted that an importance level(s) and a time period(s) and the number thereof can be set according to an abnormal mode of a road etc. which is desired to be added as an object to be reported to the road inspection server 100, 100a.

In the foregoing, each example embodiment of the present disclosure has been described. However, the present disclosure is not restricted to the aforementioned example embodiments, but further modifications, replacements and adjustments may be added within the scope of the fundamental technical concept of the present disclosure. For example, the configuration of the system, the configuration of each element and the representation form of data shown in the individual figures are an example for better understanding of the present disclosure, and thus not restricted to the configurations shown in these figures.

Furthermore, the aforementioned individual example embodiments have been described assuming that data transmission from the measuring vehicle 200, 200a is an object to be controlled. However, data measurement itself in the measuring vehicle 200, 200a may be an object to be controlled. In this case, the control part 204 of the measuring vehicle 200, 200a controls generation of measurement data based on a network band evaluated and importance of measurement data. This configuration, too, makes it possible to optimize transmission of measurement data from the measuring vehicle 200, 200a by suppressing generation and transmission of measurement data.

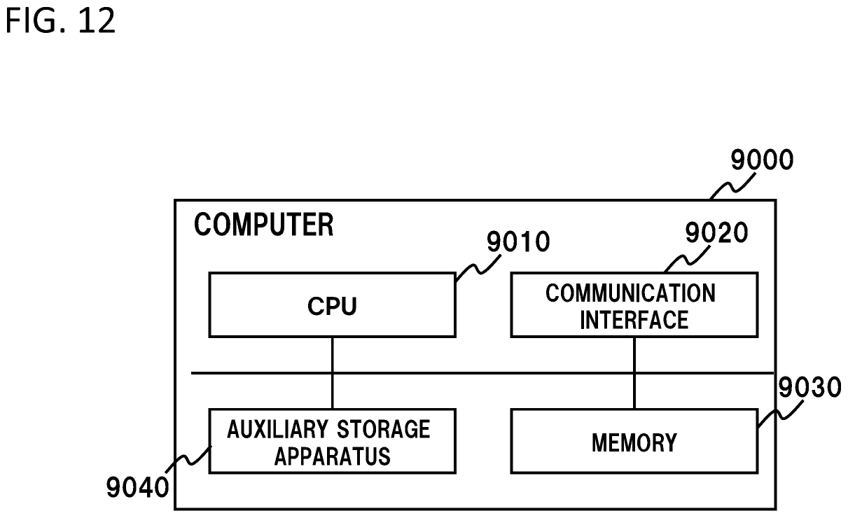

Moreover, the procedures illustrated in the abovementioned first to second example embodiments can be realized by a program that allows a computer (9000 in FIG. 12) which functions as a vehicle-mounted apparatus or a road inspection server to realize the functions as these apparatuses. Such a computer is exemplified by a configuration including a CPU (Central Processing Unit) 9010, a communication interface 9020, a memory 9030, and an auxiliary storage apparatus 9040 in FIG. 12. That is, the CPU 9010 in FIG. 12 may be made to execute a program for importance calculation processing of measurement data or a program for band evaluation of a network, and perform an update processing of individual calculation parameters stored in the auxiliary storage apparatus 9040 thereof etc.

That is, the individual parts (processing means, functions) of the individual apparatuses illustrated in the abovementioned first to second example embodiments can be implemented by a computer program which allows a processor installed in these apparatuses to execute the abovementioned individual processes, using a hardware thereof.

Finally, preferred modes of the present disclosure are summarized.

### [First Mode]

(Refer to the vehicle-mounted apparatus according to the first aspect described above.)

### [Second Mode]

Such a configuration can be adopted that the control part of the vehicle-mounted apparatus determines a threshold value of the importance of the measurement data based on the network band and performs the control by comparing the determined threshold value and the importance of the measurement data.

### [Third Mode]

Such a configuration can be adopted that the control part of the vehicle-mounted apparatus, in a case of the network band being relatively low, determines the threshold value as a value which is higher than that in a case of the network band being relatively high and generates or transmits measurement data of importance higher than that of the determined threshold value.

### [Fourth Mode]

Such a configuration can be adopted that in the vehicle-mounted apparatus, the band evaluation part classifies the network band into a plurality of levels, wherein the control part performs the control by referring to a table in which a threshold value of the importance of the measurement data is set for each of the levels.

### [Fifth Mode]

Such a configuration can be adopted that the control part of the vehicle-mounted apparatus determines a correspondence relation between the network band and the threshold of the importance based on at least one actual result value of an amount of measurement data targeted for transmission (being a transmission object) based on the network band and the importance of the measurement data and communication quality at the time of transmission of the measurement data.

### [Sixth Mode]

Such a configuration can be adopted that the control part of the vehicle-mounted apparatus controls the generation of the measurement data or the transmission of the measurement data to the server by the transmission part so as to generate temporally successive measurement data containing the measurement data targeted for the transmission (being a transmission object) based on the network band and the importance of the measurement data and transmit the same to the server.

### [Seventh Mode]

Such a configuration can be adopted that the band evaluation part of the vehicle-mounted apparatus evaluates the network band using at least one or more of a throughput, radio quality of a radio communication network included in the network, a frequency bandwidth of the radio communication network, congestion of the radio communication network, a type of the radio communication network, a time zone and a load of the server.

### [Eighth Mode]

Such a configuration can be adopted that the importance calculation part of the vehicle-mounted apparatus calculates a reliability indicating a certainty of the measurement data and assigns a high importance to measurement data for which the reliability is high.

### [Ninth Mode]

Such a configuration can be adopted that the importance calculation part of the vehicle-mounted apparatus calculates the reliability using a measurement environment of the measurement data.

### [Tenth Mode]

Such a configuration can be adopted that the importance calculation part of the vehicle-mounted apparatus calculates a severity of deterioration of the road surface state from the measurement data and assigns high importance to measurement data for which the severity of deterioration of the road surface state is high.

### [Eleventh Mode]

Such a configuration can be adopted that the importance calculation part of the vehicle-mounted apparatus specifies a type of a road from information of a position where the measurement was performed and assigns high importance to measurement data measured for a road of high required quality criterion determined according to the type.

### [Twelfth Mode]

(Refer to the control server according to the second aspect described above.)

### [Thirteenth Mode]

(Refer to the method for collecting measurement data according to the third aspect described above.)

### [Fourteenth Mode]

(Refer to the program according to the fourth aspect described above.)

It is to be noted that the aforementioned twelfth to fourteenth modes can be extended to the second to eleventh modes as with the first mode.

It is to be noted that the individual disclosures of the abovementioned Patent Literatures are incorporated herein by reference thereto and can be used as a basis or a part of the present invention as required. Modifications and adjustments of example embodiments and examples may be made within the scope of the entire disclosure (including the scope of the claims) of the present invention, and also based on the fundamental technical concept thereof. Various combinations and selections (including partial deletions) of various disclosed elements (including individual elements of each claim, individual elements of each example embodiment and example, individual elements of each figure and the like) are possible within the scope of the disclosure of the present invention. That is, it is self-explanatory that the present invention includes various types of transformations and modifications that a person skilled in the art can realize according to the entire disclosure including the Claims and the technical concept thereof. In particular, with regard to numerical ranges described in the present specification, arbitrary numerical values and small ranges included in the relevant ranges should be interpreted to be specifically described even if there is no particular description thereof. Moreover, it is deemed that it is included in the disclosed matters of the present application that a portion or the whole of the individual disclosed matters of the above-cited literatures are used, as required, based on the gist of the present invention and as a part of the disclosure of the present invention, in combination with the disclosed matters of the present application.

### REFERENCE SIGNS LIST

20 vehicle-mounted apparatus
21, 201 measurement part
22, 101, 202 band evaluation part
23, 203 importance calculation part
24, 204 control part
25, 205 transmission part
100, 100a road inspection server
102 band evaluation notifying part
200, 200a measuring vehicle
206 camera
9000 computer
9010 CPU
9020 communication interface
9030 memory
9040 auxiliary storage apparatus

What is claimed is:

1. A vehicle-mounted apparatus, comprising:
at least one memory configured to store instructions; and
at least one processor configured to execute the instructions to:
measure a road surface state in which a vehicle travels,
evaluate a network band between it the vehicle and a server at a transmission destination of measurement data of the road surface state,
calculate importance of the measurement data based on a predetermined importance determination policy,
transmit the measurement data to the server, and
control generation of the measurement data by the measurement part or transmission of the measurement data to the server by the transmission part based on the network band and the importance of the measurement data.

2. The vehicle-mounted apparatus according to claim 1, wherein the at least one processor is configured to execute the instructions to: determine a threshold value of the importance of the measurement data based on the network band, and perform the control by comparing the determined threshold value and the importance of the measurement data.

3. The vehicle-mounted apparatus according to claim 2, wherein the at least one processor is configured to execute the instructions to: part, in a case of the network band being relatively low, determine the threshold value as a value which is higher than that in a case of the network band being relatively high, and generate or transmit measurement data of importance higher than that of the determined threshold value.

4. The vehicle-mounted apparatus according to claim 2, wherein the at least one processor is configured to execute the instructions to: classify the network band into a plurality of levels, and perform the control by referring to a table in which a threshold value of the importance of the measurement data is set for each of the levels.

5. The vehicle-mounted apparatus according to claim 2, wherein the at least one processor is configured to execute the instructions to determine a correspondence relation between the network band and the threshold of the importance based on at least one actual result value of an amount of measurement data targeted for transmission based on the network band and the importance of the measurement data and communication quality at the time of transmission of the measurement data.

6. The vehicle-mounted apparatus according to claim 1, wherein the at least one processor is configured to execute the instructions to control the generation of the measurement data or the transmission of the measurement data to the server by the transmission part so as to generate temporally successive measurement data containing the measurement data targeted for the transmission based on the network band and the importance of the measurement data and transmit the same to the server.

7. The vehicle-mounted apparatus according to claim 1, wherein the at least one processor is configured to execute the instructions to evaluate the network band using at least one or more of a throughput, radio quality of a radio communication network included in the network, a frequency bandwidth of the radio communication network, congestion of the radio communication network, a type of the radio communication network, a time zone and a load of the server.

8. The vehicle-mounted apparatus according to claim 1, wherein the at least one processor is configured to execute the instructions to: calculate a reliability indicating a certainty of the measurement data and assign a high importance to measurement data for which the reliability is high.

9. The vehicle-mounted apparatus according to claim 8, wherein the at least one processor is configured to execute the instructions to calculate the reliability using a measurement environment of the measurement data.

10. The vehicle-mounted apparatus according to claim 1, wherein the at least one processor is configured to execute the instructions to: calculate a severity of deterioration of the road surface state from the measurement data, and assign high importance to measurement data for which the severity of deterioration of the road surface state is high.

11. The vehicle-mounted apparatus according to claim 1, wherein the at least one processor is configured to execute the instructions to: specify a type of a road from information of a position where the measurement was performed, and assign high importance to measurement data measured for a road of high required quality criterion determined according to the type.

12. A control server, comprising
a band evaluation part that evaluates a network band between a vehicle including a measurement part capable of measuring, by means of a sensor, a road surface state in which the vehicle travels, an importance calculation part that calculates importance of the measurement data based on a predetermined importance determination policy, a transmission part capable of transmitting the measurement data of the road surface state to the server and a control part, and a server at a transmission destination of the measurement data, and
a notification part that notifies the vehicle of the network band,
the control server comprising a processor and a memory storing instructions executed by the processor, the instructions comprising an instruction allowing the control part of the vehicle to control generation of the measurement data by the measurement part of the vehicle or transmission of the measurement data to the server by the transmission part of the vehicle based on the network band and importance of the measurement data.

13.-15. (canceled)

16. A computer-readable, non-transitory program recording medium recording a program to
allow a control server including a communication part capable of communication with a vehicle-mounted apparatus of a vehicle including a measurement part capable of measuring, by means of a sensor, a road surface state in which a vehicle travels, a importance calculation part that calculates importance of measurement data based on a predetermined importance determination policy, a transmission part capable of transmitting measurement data of the road surface state to a server, and a control part to execute
process of evaluating a network band between it the vehicle and a server at a transmission destination of the measurement data, and
process of notifying the vehicle-mounted apparatus of the vehicle of the network band, and
allow the control part of the vehicle to control generation of the measurement data by the measurement part of the vehicle or measurement of the road surface state by the measurement part of the vehicle or transmission of the measurement data to the server by the transmission part of the vehicle based on the network band and importance of the measurement data.

17. The control server according to claim 12, wherein the instructions comprise an instruction allowing the control part to determine a threshold value of the importance of the measurement data based on the network band, and to perform the control by comparing the determined threshold value and the importance of the measurement data.

18. The control server according to claim 17, wherein the instructions comprise an instruction allowing the control part, in a case of the network band being relatively low, to determine the threshold value as a value which is higher than that in a case of the network band being relatively high, and to generate or transmit measurement data of importance higher than that of the determined threshold value.

19. The control server according to claim 17, wherein the instructions comprise an instruction allowing the control part to determine a correspondence relation between the network band and the threshold of the importance based on at least one actual result value of an amount of measurement data targeted for transmission based on the network band and the importance of the measurement data and communication quality at the time of transmission of the measurement data.

20. The control server according to claim 12, wherein the instructions comprise an instruction allowing the importance calculation part to calculate a reliability indicating a certainty of the measurement data and to assign a high importance to measurement data for which the reliability is high.

21. The program recording medium according to claim 16, wherein the program allows the control server to execute process of allowing the control part to determine a threshold value of the importance of the measurement data based on the network band, and to perform the control by comparing the determined threshold value and the importance of the measurement data.

22. The program recording medium according to claim 21, wherein the program allows the control server to execute process of allowing the control part to determine a correspondence relation between the network band and the threshold of the importance based on at least one actual result value of an amount of measurement data targeted for transmission based on the network band and the importance of the measurement data and communication quality at the time of transmission of the measurement data.

23. The program recording medium according to claim 16, wherein the program allows the control server to execute process of allowing the importance calculation part to calculate a reliability indicating a certainty of the measurement data and to assign a high importance to measurement data for which the reliability is high.
